(19) United States
(12) Patent Application Publication
(10) Pub. No.: US 2026/0162291 A1
(43) Pub. Date: Jun. 11, 2026

(54) ARTIFICIAL INTELLIGNCE STEREO DISPARITY ESTIMATION

(71) Applicant: NVIDIA Corporation, Santa Clara, CA (US)

(72) Inventor: Dong Zhang, Hangzhou (CN)

(21) Appl. No.: 18/972,446

(22) Filed: Dec. 6, 2024

(51) Int. Cl. G06T 7/593

(52) U.S. Cl. CPC G06T 7/593; G06T 2207/10012; G06T 2207/20081; G06T 2207/20084

(57) ABSTRACT

Disclosed are systems and techniques for AI stereo disparity estimation. The techniques include generating a cost volume matrix based on a stereo image pair. The techniques include generating a disparity maps for the first image of the stereo image pair, which includes, for each pixel in the first image, generating a disparity value corresponding to the pixel by performing stereo image processing on the cost volume matrix entry corresponding to the pixel to generate an intermediate stereo image processing output, generating, using the intermediate stereo image processing output as input to a CNN, one or more weight values, and calculating, for the pixel, the disparity value using one or more intermediate disparity values of the intermediate stereo image processing output and the plurality of weight values.

### TECHNICAL FIELD

At least one embodiment pertains to computer vision, and more specifically, to using artificial intelligence (AI) to generate a disparity map for a pair of stereo images.

### BACKGROUND

Dense stereo matching is a computer vision technique that estimates the depth of each pixel in a pair of images captured from slightly different locations. This is achieved by determining points in the two images that correspond to the same location, known as disparity. The disparity value represents the locational shift between the corresponding pixels in the two images. The disparity values can be arranged into a disparity map, which can be a two-dimensional image where each pixel's value corresponds to the disparity value at a corresponding pixel from the original images. Dense stereo matching (and the resulting disparity map) allows for estimation of distances to different points using only a pair of images, which can alleviate the need to use remote sensing technologies, such as lidar, sonar, or radar.

### BRIEF DESCRIPTION OF THE DRAWINGS

FIG. 1 is a block diagram of an example system for artificial intelligence (AI) stereo disparity estimation, according to at least one embodiment.

FIG. 2 is a block diagram of an example stereo image matcher for AI stereo disparity estimation, according to at least one embodiment.

FIG. 3 shows an example of consensus transform and hamming distance computations performed by a cost/volume constructor of FIG. 2, according to some example embodiments.

FIG. 4 is a block diagram of an example SGM/eSGM block for AI stereo disparity estimation, according to at least one embodiment.

FIG. 5A illustrates example path directions that are configurable for SGM/eSGM computations that can be used in some example embodiments.

FIG. 5B illustrates multiple iterations of SGM/eSGM implementations, according to some embodiments.

FIG. 6 is a block diagram of an example AI model for AI stereo disparity estimation, according to at least one embodiment.

FIG. 7 is an example data flow diagram for AI stereo disparity estimation, according to at least one embodiment.

### DETAILED DESCRIPTION

Various techniques for dense stereo matching exist, such as semi-global matching (SGM) and efficient semi-global matching (eSGM). In order to calculate a disparity value associated with a pixel of an image, SGM and eSGM generate multiple paths to that pixel, and each path includes disparity values, one of which is selected as the disparity value for the pixel. One disadvantage of SGM and eSGM is that they give equal weight to each path, which is usually incorrect. For example, where the image has texture along a horizontal direction, then the paths along the horizontal direction should be given more weight than the other paths. Because of this, SGM and eSGM generate low-quality disparity estimates for pixels corresponding to small or thin vertical areas, such as poles or signposts, or for pixels corresponding to areas where the texture has a strong orientation, such as a road surface.

Aspects of the present disclosure address the above and other deficiencies by providing a stereo image matcher with an artificial intelligence (AI) model that uses intermediate outputs of SGM or eSGM to determine disparity values for pixels instead of using the disparity values estimated by SGM or eSGM. The AI model may be a convolutional neural network (CNN) that has been trained to output a weight associated with each path to a pixel generated by SGM or eSGM. Disparity values from the paths may be combined using the associated weights to determine the disparity value for the pixel. The determined disparity values can be used to generate a disparity map.

Advantages of the disclosed embodiments over the existing technology include, but are not limited to, increased accuracy for disparity maps for use in determining distances to different points, especially for areas where conventional dense stereo matching has provided poor results.

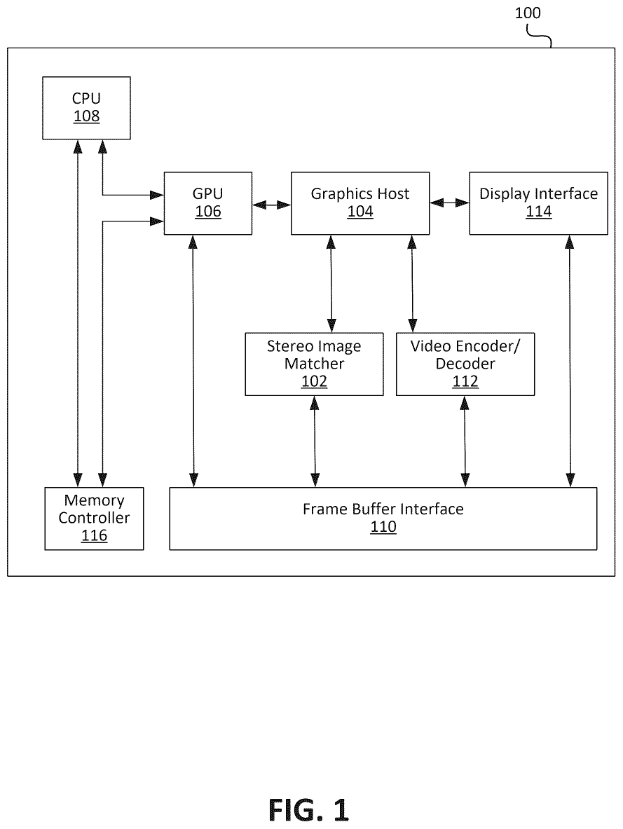

FIG. 1 schematically illustrates a system for AI stereo disparity estimation, according to some example embodiments. The illustrated system 100 may be a computing device, a system on a chip (SoC), or some other type of device that includes specialized stereo image matching circuitry in the form of a stereo image matcher. The system 100 may be used in various implementations. For example, the system 100 may be part of an automotive system (including an autonomous or semi-autonomous vehicle) capable of object/pedestrian detection/tracking, structure from motion (SFM) determination, simultaneous localization and mapping (SLAM), etc. The system 100 may be used with virtual reality applications, for example, for 360-degree video stitching. The system 100 may be used in gaming applications, such as frame rate upconversion. The system 100 may be used with deep learning applications, such as video classification. The system 100 may be used in other applications that use stereo disparity.

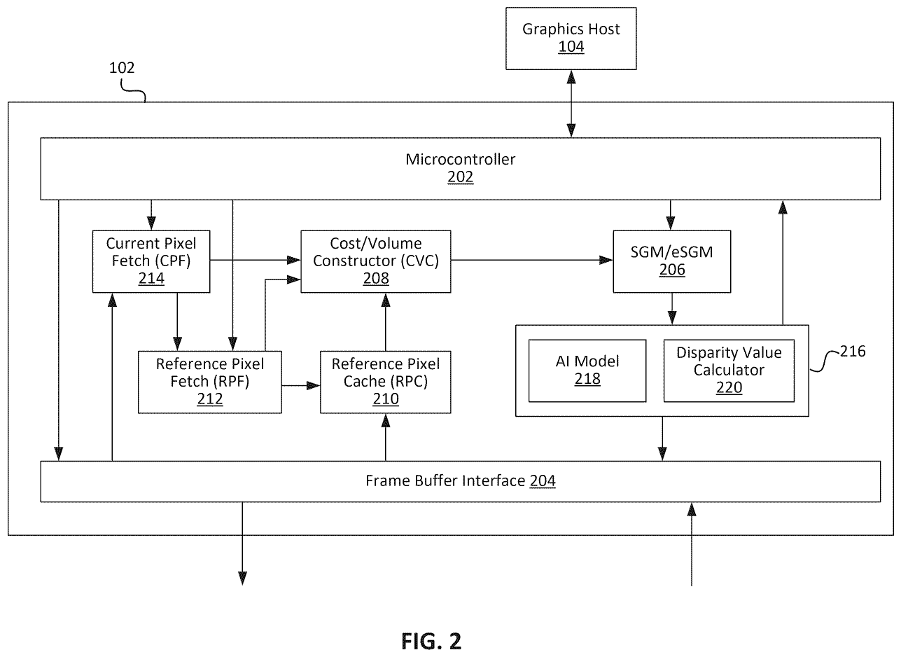

In some embodiments, the system 100 includes a stereo image matcher 102. The stereo image matcher 102 may include one or more processors, processing units, or other circuitry that is at least configured to generate a stereo disparity map from input images and related input information. As noted above and further noted below in relation to FIGS. 2-7, the stereo image matcher 102 implements SGM or eSGM to generate intermediate outputs, and the stereo image matcher 102 implements a trained CNN that uses the intermediate outputs to generate stereo disparity determinations (e.g., in the form of a disparity map corresponding to the input images).

A graphics processing unit (GPU) 106 may be connected to the stereo image matcher 102 directly and/or indirectly through a graphics host 104. The graphics host 104 provides a programming and control interface to various graphic and video engines, and to display interface(s). The graphics host 104 can also have interfaces (not shown in FIG. 1) to a switch (e.g., a crossbar switch or the like) to connect with other components and a direct memory interface to fetch command and/or command structures from system memory. In some embodiments, commands and/or command structures are either gathered from a push buffer in memory or provided directly by the central processing unit (CPU) 108 and then supplied to clients that are also connected to the graphics host, such as the stereo image matcher 102. An audio/video frame encoder/decoder 112 is connected through the graphics host 104. The audio/video frame encoder/decoder 112 may support playback and/or generation of full motion high resolution (e.g., 1440p high definition) video in any format, such as H.264 BP/MP/HP/MMC, VC-1, VP8, MPEG-2, or MPEG-4.

The stereo image matcher 102 may obtain its input images and may write its output images to a memory (not shown in FIG. 1) such as a frame buffer memory that is accessed through a frame buffer interface 110. Many components in the system 100, including, for example, the GPU 106, the stereo image matcher 102, the video encoder/decoder 112, or the display interface 114 may connect to the frame buffer interface 110 to access the frame buffer.

The CPU 108 may control the processing on the system 100 and may be connected to the GPU 106. The CPU 108 and GPU 106 may be connected to a memory controller 116 to access an external memory.

In an example embodiment, when the system 100 is incorporated, for example, in an automotive application, incoming video from one or more cameras attached to the automobile (or other vehicle) may be received by the video encoder/decoder 112, which decodes the video and writes the video frames to the frame buffer (not shown) through the frame buffer interface 110. The video frames are then obtained from the frame buffer by the stereo image matcher 102 to generate a disparity map, which is provided to the GPU 106 through the framebuffer. The GPU 106 may use the generated disparity map for further processing in any application, such as, but not limited to, object detection and/or tracking.

In some embodiments, the GPU 106 or the CPU 108 may perform one or more of the operations described herein as being performed by the stereo image matcher 102. For example, may obtain executable instructions for the one or more stereo image matcher 102 operations from the memory controller 116, and the GPU 106 or the CPU 108 may execute those instructions.

FIG. 2 schematically illustrates the example circuitry the stereo image matcher 102 shown in FIG. 1, according to some embodiments. In FIG. 2, the stereo image matcher 102 is shown connected to the graphics host 104. The stereo image matcher 102 circuitry may include a microcontroller 202, a frame buffer interface 204 (which may be different from the frame buffer interface 110 of FIG. 1 or may be the same), an SGM/eSGM block 206, a cost volume constructor (CVC) block 208, a reference pixel cache (RPC) block 210, a reference pixel fetch (RPF) block 212, and a current pixel fetch (CPF) block 214, and an AI block 216. The AI block 216 can include an AI model 218 and a disparity value calculator 220.

The microcontroller 202 may connect to the graphics host 104 from which it receives instructions and data. The microcontroller 202 can connect multiple components in the stereo image matcher 102 to control the operations in the stereo image matcher 102 in accordance with instructions received from the graphics host 104.

The microcontroller 202 may include interfaces for signals such as, context switch signals, microcode for certain instructions, addresses and other data, privilege bus, and interrupt interface with the graphics host 104. It may process the microcode, address, data and/or other signals received and may drive the rest of the stereo image matcher 102. The microcontroller 202 can also perform error handling, and may perform other tasks, such as rate control and general (e.g., macroblock level) housekeeping, tracking and mode decision configuration. The microcontroller 202 may receive interrupt requests, status data, or control data from the AI block 216.

The frame buffer interface 204 may enable the stereo image matcher 102 to read from and write to a frame buffer (e.g., the frame buffer interface 110 of FIG. 1). For example, data, such as the image frames, that are input to the stereo image matcher 102 may be read into the stereo image matcher 102 via the frame buffer interface 204 in accordance with control signals received from the microcontroller 202. The disparity maps generated as output by the stereo image matcher 102 may be written to the frame buffer via the frame buffer interface 204.

The SGM/eSGM block 206 may include circuitry for one-dimensional (1D) and/or two-dimensional (2D) SGM/eSGM operations, historical and/or temporal path cost generation, and winner decision. The SGM/eSGM block 206 may also support aspects of postprocessing. The SGM/eSGM block 206 may be configurable to enable the 1D or 2D SGM/eSGM to be performed along a configurable number of paths (e.g., 4 or 8 paths). The SGM/eSGM processing may also be configurable for different disparity levels (e.g., 128 or 256 disparities) for stereo SGM/eSGM and epipolar SGM/eSGM. The “disparity levels” parameter can define the search space used for matching. That is, when the disparity level is D, for each pixel p in the base image, D pixels in the reference image are searched for matching creating D disparity levels associated with p.

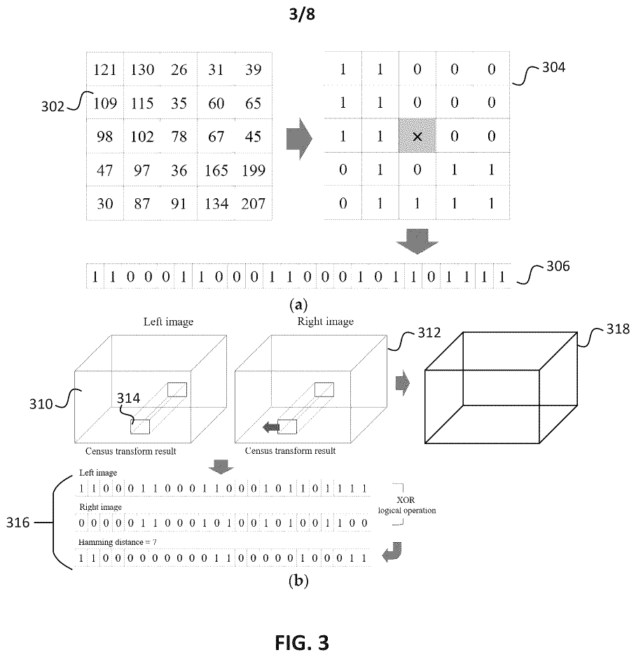

The SGM/eSGM block 206 may, in some embodiments, implement any or none of equiangular subpixel interpolation, adaptive smoothing penalties, and wavefront processing (e.g., for bandwidth saving). The equiangular subpixel interpolation can be performed for subpixel refinement, and, in some embodiments, may be enabled or disabled based on a configuration parameter. The SGM/eSGM block 206 may provide a unified architecture for stereo disparity and may provide configurable scalability between quality and performance. The SGM/eSGM block 206 may also provide for configurable motion vector/disparity granularity (e.g., minimum 1×1 to maximum 8×8), configurable number of disparity levels and search range, and/or cost calculation on original resolution to preserve matching precision. Further details regarding the SGM/eSGM block 206 are provided below in relation to FIGS. 3, 4, and 5A-C.

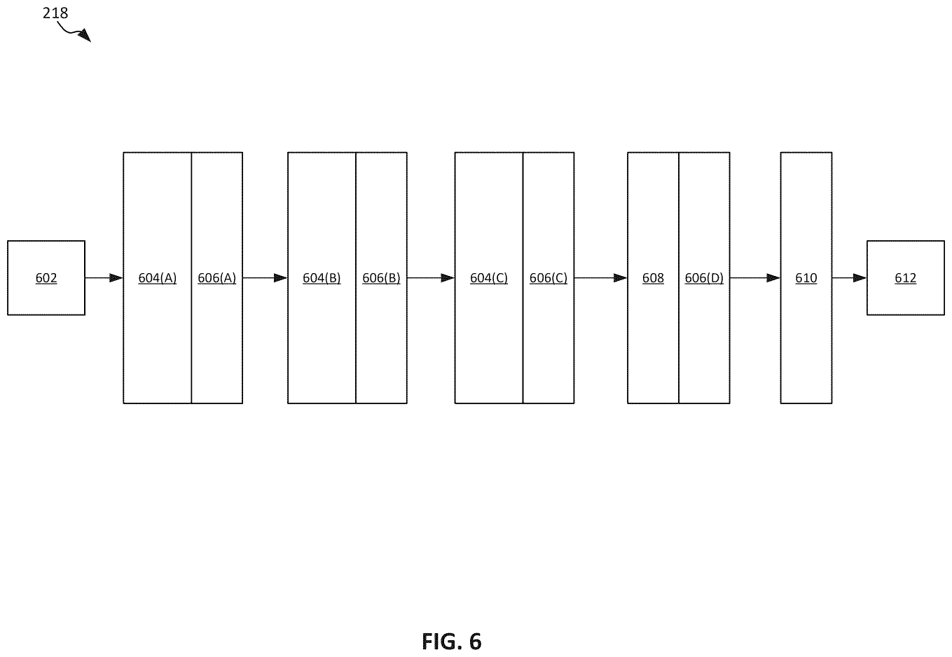

As part of performing SGM/eSGM operations, the SGM/eSGM block 206 may generate an intermediate stereo image processing output. The SGM/eSGM block 206 may provide the intermediate stereo image processing output to the AI block 216, as discussed below in relation to FIG. 6.

The CVC block 208 may include circuitry operable to generate the cost volume corresponding to input images. The “cost volume” (also called “matching cost volume”) is a three-dimensional (3D) array in which each element represents the matching cost of a pixel at a particular disparity level. The cost volume matrix 318 shown in FIG. 3 is an example. The CVC block 208 may be configured to perform a variety of operations, including performing census transform (e.g., a 5×5 census transform) for both current and reference pixels, and calculating the hamming distance between current and reference pixel census transformed data blocks, as discussed below in relation to FIG. 3.

The CPF block 214 may include circuitry operable to obtain a current pixel or a next pixel to be evaluated. The RPC block 210 and the RPF block 212 may include circuitry operable to obtain and store the reference pixels that correspond to each pixel fetched by the CPF block 214. The RPC block 210 may include a cache for storing reference pixels and may reduce the memory bandwidth due to reference pixel fetch. The RPC block 210 may accept the fetch request from the RPF block 212, fetch the reference pixels from external memory, and output reference pixel block to the CVC block 208.

The AI block 216 may obtain the intermediate stereo image processing output from the SGM/eSGM block 206. The AI block 216 may provide the intermediate stereo image processing output to the AI model 218 as input, and the AI model 218 may generate one or more weight values. The disparity value calculator 220 may use the one or more weight values and portions of the intermediate stereo image processing output (e.g., intermediate disparity values) to calculate a disparity value for a current pixel. The disparity value calculator 220 may generate the disparity map using the calculated disparity values for the pixels and provide the disparity map to the frame buffer interface 204. The disparity value calculator 220 may provide the calculated disparity values to the frame buffer interface 204, and a separate component may generate the disparity map using the calculated disparity values. Further information regarding the AI block 216 is provided below in relation to FIG. 6.

As an example overview of the AI stereo disparity estimation process implemented by the SGM/eSGM block 206, the CVC block 208, and the AI block 216 (and supported by the various other components of the stereo image matcher 102), the CVC block 208 generates a cost volume matrix that includes a cost that corresponds to each pixel in the first image of an input stereo image pair. The CVC block 208 provides the cost volume matrix to the SGM/eSGM block 206. For each pixel in the first image of the stereo image pair, the SGM/eSGM block 206 performs stereo image processing using the cost volume matrix entry corresponding to that pixel to generate an intermediate stereo image processing output for that pixel. The intermediate stereo image processing output is then provided to the AI block 216, which uses the AI model 218 and the disparity value calculator 220 to calculate a disparity value for the current pixel (instead of using the disparity value generated by the SGM/eSGM block 206). The stereo image matcher 102 may repeat the stereo image processing and AI operations for each pixel in the first image to generate a disparity value for each pixel in the first image. The disparity values are then organized into a disparity map, which the system 100 can use in various applications.

FIG. 3 shows an example of consensus transform and hamming distance computations performed by the CVC block 208 of FIG. 2, according to some example embodiments. The pixel block 302, which in the example is a 5×5 pixel block, may be the current pixel block fetched when the CPF block 214 fetches the center pixel x as the current pixel. The value of each pixel in the fetched pixel block may represent an intensity value.

The census transform, which may be used in some embodiments, is a non-linear transformation which maps a local neighborhood surrounding a pixel P, indicated as the pixel block 302, to a binary string 306 representing the set of neighboring pixels whose intensity is less than that of P, indicated as the pixel block 304. Each census digit ξ(P, P′) is defined by the following relationship:

$$ξ ( P , {P}^{′} ) = \{ \begin{matrix}0 , & P > {P}^{′} \\ 1 , & P \leq {P}^{′}\end{matrix} \}$$

That is, for a pixel P, each pixel P′ in its neighborhood is represented as a 1 or a 0 based on whether P′ is greater than or equal to or is lesser than P, respectively. The size of the local neighborhood of pixel P for census transform may be configurable. Based upon an output quality versus chip area tradeoff, in some example embodiments, a 5×5 census transform is used in the CVC block 208. The binary string 306 is derived from the census transformed block 304 by linearly arranging the rows from top to bottom.

For each pixel P, the binary string 306 representing the set of neighboring pixels for two images is then subjected to the hamming distance determination, as shown by 316. The hamming distance is a distance metric used to measure the difference of two-bit string values. In the context of the CVC block 208, the hamming distance is the number of the different bits in two census transform strings. The hamming distance for pixel P can be determined by XORing the two-bit strings and counting the number of 1s.

The census transform result arrays 310 and 312 represent census transform results for corresponding left and right stereo images respectively, according to an example. The census transform result array 310 may be considered as the collection of census-transformed results (i.e., the binary strings 306 corresponding to each pixel of the image) for each pixel in the left image. Likewise, the census transform result array 312 may be considered as the collection of census-transformed results for each pixel in the right image. 314 illustrates an example of the current pixel p with its bit string in the left image and a reference pixel with its bit string in the right image.

316 shows the hamming distance calculation by performing an XOR operation on the census transformed results taken from the left and right images, as discussed above. The census transform result arrays 310 and 312 are compared according to the equation:

$$C ( x , y , d ) = {\sum }_{{x}^{′} , {y}^{′} ∈ [ x \pm 2 , y \pm 2 ]} Hamming Distance ( {CT}_{0} ( {x}^{′} , {y}^{′} ) , {CT}_{1} ( {x}^{′} - d , {y}^{′} ) )$$

to generate a 3D disparity space called the cost volume matrix 318. CT₀ is the census transform result array 310, and CT₁ is the census transform result array 312. The CVC 208 provides the cost volume matrix 318 to the SGM/eSGM block 206 for use in stereo image processing.

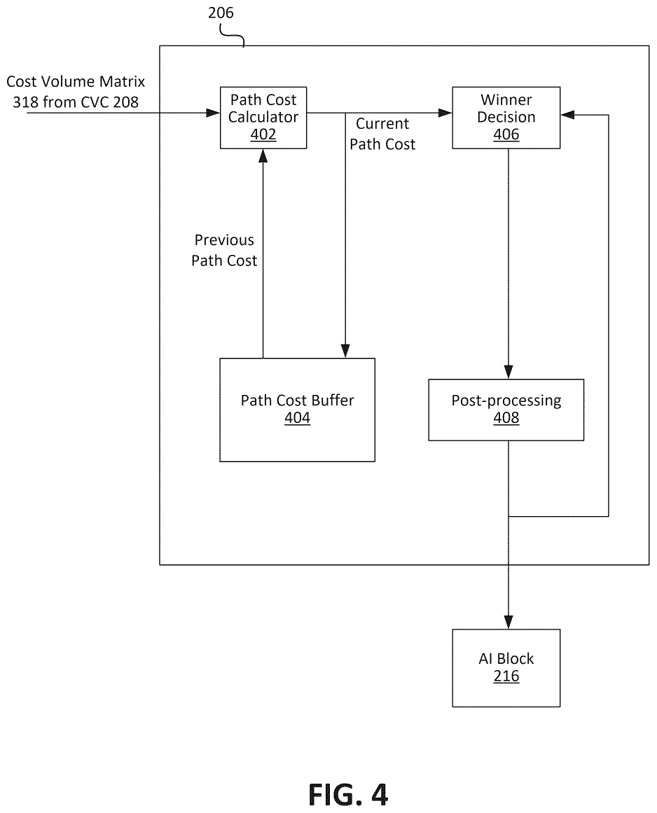

FIG. 4 is a schematic block diagram of an example SGM/eSGM block 206, according to some embodiments. In the stereo image matcher 102, the SGM/eSGM block 206 may be the sub-unit that receives the cost volume matrix 318 from the CVC block 208, performs SGM/eSGM operations, and performs post-processing on the resulting disparity values (e.g., the winner disparity value). SGM/eSGM are dynamic-programming-based algorithms used for stereo disparity estimation.

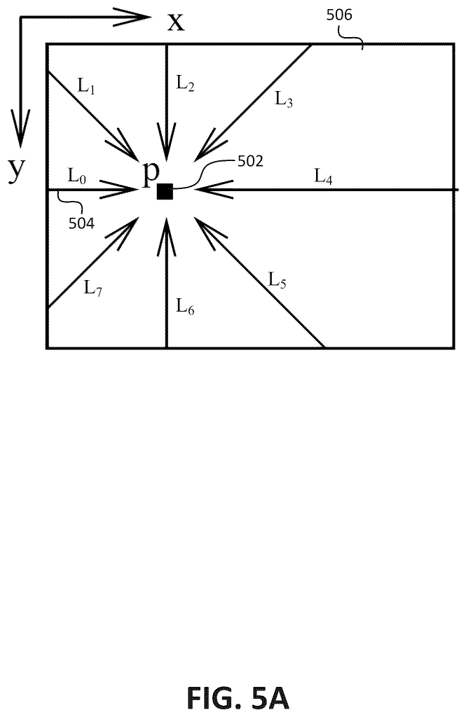

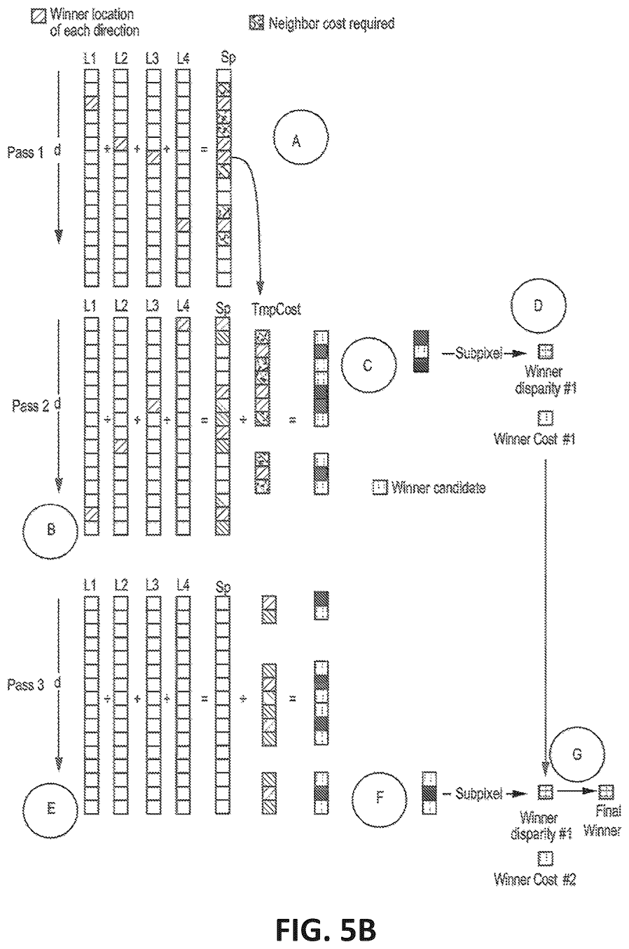

The cost volume matrix 318 from the CVC block 208 is received by a path cost calculator 402. The path cost calculator 402 may be configured to use the cost volume matrix 318 to calculate a path cost along a path to a pixel of the input stereo image pair. The path cost calculator 402 may use at least a portion of the cost volume matrix 318 to calculate one or more path costs to the current pixel. The path cost calculator 402 may use a previously calculated path cost to calculate a current path cost. The path cost calculator 402 may receive the previously calculated path cost from the path cost buffer 404, which may store one or more previously calculated path costs. Calculating the one or more path costs is discussed below in relation to FIG. 5A.

The one or more path costs calculated by the path cost calculator 402 may be provided to the path cost buffer 404 for storage. The one or more path costs may also be provided to the winner decision block 406. The winner decision block 406 may select a path cost that contains the winning disparity and may output one or more path costs and/or one or more disparity values, as discussed below in relation to FIG. 5B.

The output of the winner decision block 406 can be provided to the post-processing block 408. The post-processing block 408 may perform post-processing operations, which may include error correction, subpixel interpolation, vz-index-to-motion vector conversion, disparity-to-motion vector conversion, or other post-processing operations. After the post-processing by the post-processing block 408, the result may be provided back to the winner decision block 406. The result may be provided to the AI block 216.

Features supported by the SGM/eSGM block 206, in some embodiments, include supporting a configurable maximum number of possible disparity values (e.g., 256 or 128 disparities, where the lower number of disparities can be selected for faster performance). Other supported features may include a configurable number of directions in which to evaluate matching costs, for example, 2 (horizontal and vertical); 4 (horizontal, vertical, left, and right), or 8 (horizontal, vertical, left, right, and the four diagonals), and support for a configurable number of SGM passes (e.g., 1, 2, or 3).

FIG. 5A illustrates example path directions for SGM/eSGM that can be used in some embodiments. In some embodiments, the number of paths 504 considered when determining path costs for a pixel p 502 may be configurable. For example, in the illustrated image frame 506, the matching cost associated with pixel p 502 can be determined based on four paths (e.g., up L₂, down L₆, left L₀, and right L₄) or eight paths (e.g., L₀-L₇). In some embodiments, SGM/eSGM may use another subset of the eight paths L₀-L₇ and/or additional paths.

In some embodiments, the path cost calculator 402 may calculate the path cost L for pixel p along a direction r for d disparity levels is as follows:

$${L}_{r} ( p , d ) = C ( p , d ) + temp ( p , d ) - {min}_{i} {L}_{r} ( p - r , i )$$

$$temp ( p , d ) = min \{ \begin{matrix}{L}_{r} ( p - r , d ) \\ min {L}_{r} ( p - r , d \pm 1 ) + P 1 \\ {min}_{i} {L}_{r} ( p - r , i ) + P 2\end{matrix}$$

In the above recursive computation, in order to determine the path cost L for a pixel p along a path r, all path costs from the previous pixel along direction r (represented as “p-r”), and two penalty terms P1 and P2 are used. C (p, d) is the sum of all pixel matching costs for the disparities of d. temp(p, d) adds a constant penalty P1 for all pixels in the neighborhood of p, for which the disparity changes by a small amount (e.g., 1 pixel). minᵢLᵣ (p-r, i) adds a larger constant penalty P2, for all larger disparity changes. Using a lower penalty for small changes permits an adaptation to slanted or curved surfaces. The constant penalty for all larger changes (e.g., independent of their size) preserves discontinuities. P1 and P2, in relation to SGM/eSGM techniques, are referred to as matching cost smoothing penalties. As an optimization technique in some embodiments, in addition to storing all the path cost values, the minimum path cost of previous pixels is also stored in an on-chip buffer (e.g., the path cost buffer 404) to avoid recalculating minᵢL (p-r, i).

In one embodiment, the SGM/eSGM block 206 may use a temporal buffer to store the data of a previous SGM/eSGM pass (e.g., in the path cost buffer 404). The buffer may be of the size W×H×dMax where W is the width of the original stereo image, H is the height of the original stereo image, and dMax is the maximum possible disparity value (e.g., 128 or 256). In order to reduce the size of the buffer, the SGM/eSGM block 206 may use a buffer whose size is:

$$bufferSize = W \times H ( pathNum \times ( bytesPerDisp + costNum \times bytesPerCost ) + bytesWinnerDisp + bytesWinnerCost )$$

where pathNum is the number of aggregation paths (e.g., 1, 2, or 3), bytesPerDisp is the number of bytes used to represent a disparity value, costNum is the number of costs for subpixel interpolation (e.g., 3), bytesPerCost is the number of bytes used to represent a path cost, bytesWinnerDisp is the number of bytes used to represent the winning disparity value, and bytes WinnerCost is the number of bytes used to represent the winning path cost.

In some embodiments, the SGM/eSGM process of the SGM/eSGM block 206 uses a 3-pass process. An example 3-pass process is shown in FIG. 5B. Operation “A” shows the first pass, in which the path cost array for each of paths L₀, L₁, L₂, and L₃ have a winner pixel identified by a shading pattern. The sum of all path costs is represented by the “Sp” array. Sp represents the winner pixels from each of the four paths and also identifies the pixels adjacent to the winner pixels, for example, because certain calculations may use neighbor pixel information, as discussed below. In the processes discussed below, the following notation is used:
L_{direction}^{#pass}(pixel location, disparity): path cost for the indicated direction and passes, as indexed by the given disparity;
Sp^{#pass}(pixel location, disparity): partial sum of the path cost of the 4 directions of the indicated pass, as indexed by the given disparity;
S: aggregated path cost from all 8 directions; and
d_{direction}^{#pass}: winner disparity value along the indicated direction for the indicated pass

In some embodiments, the first pass of operation “A” is performed from the upper left of the image to the bottom right. The first pass may include, for each pixel:
Calculate Lᵣ¹ (p, d) for the 4 directions;
Calculate Sp¹=L₀¹ (p, d₀)+L₁¹ (p, d₁)+L₂¹ (p, d₂)+L₃¹ (p, d₃);
Select the minimum Lᵣ¹ (p, d) from among the 4 path costs, dᵣ¹ is the disparity value corresponding to the selected path cost; and
Output Sp¹(p, dᵣ¹), Sp¹(p, dᵣ¹+1), Sp¹(p, dᵣ¹−1), and dᵣ¹, where dᵣ¹+1 and dᵣ¹−1, are the disparity values corresponding to the pixels that neighbor the winning pixel (i.e., the pixel corresponding to dₘᵢₙ¹).

Operation “B” shows the second pass, in which the path cost array for each of paths L₄, L₅, L₆, and L₇ are determined, and illustrates the determination of the winner candidates in operation “C”. The sum array from the first pass is summed with the sum array from the second pass to generate a first winner candidate array. Then, the first winner is selected from the first winner candidate array and, at operation “D,” is subjected to subpixel refinement (discussed further below) in order to generate the first winner disparity.

In some embodiments, the second pass is performed from the bottom right to the upper left of the image. The second pass may include, for each pixel:
Load Sp¹(p, dᵣ¹), Sp¹(p, dᵣ¹+1), Sp¹(p, dᵣ¹−1), and dᵣ¹;
Calculate Lᵣ²(p, d) for the 4 directions;
Calculate Sp²=L₄²(p, d₄)+L₅²(p, d₅)+L₆²(p, d₆)+L₇²(p, d₇)
Calculate S(p, dᵣ¹)=Sp¹(p, dᵣ¹)+Sp²(p, dᵣ¹),
Calculate S(p, dᵣ¹+1)=Sp¹(p, dᵣ¹+1)+Sp²(p, dᵣ¹+1);
Calculate S(p, dᵣ¹−1)=Sp¹(p, dᵣ¹−1)+Sp²(p, dᵣ¹−1);
Select the minimum Lᵣ^{1 or 2}(p, d) from among the 8 paths costs of S(p, dᵣ¹), d* is the disparity value corresponding to the selected path cost;
Perform subpixel interpolation on d* using S(p, dᵣ¹), S(p, dᵣ¹+1), and S(p, dᵣ¹−1);
Select the Lᵣ²(p, d) with the minimum cost value and disparity value corresponding to the selected path cost (dᵣ²); and
Output Sp²(p, dᵣ²), Sp²(p, dᵣ²+1), Sp²(p, dᵣ²−1), and dᵣ²

Operation “E” shows the third path, where path costs for L₀-L₃ are determined in the third pass and the sum of the third pass path costs is summed to yield winner candidates at operation “F”. Then a winner selected from the third pass winner candidates is subjected to subpixel refinement to obtain a second winner disparity and second winner cost. Then at operation “G”, a final winner is selected based on the first winner disparity and first winner cost determined at the second pass and the second winner disparity and the second winner cost determined at the third pass.

The third pass is performed from the upper left of the image to the bottom right. In the third pass, for each pixel:
Load Sp²(p, dₘᵢₙ²), Sp²(p, dₘᵢₙ²+1), Sp²(p, dₘᵢₙ²−1), and dₘᵢₙ²;
Load S(p, d*), d*;
Calculate Lᵣ³(p, d) for the 4 directions;
Calculate Sp³=L₀³(p, d₀)+L₁³(p, d₁)+L₂³(p, d₂)+L₃³(p, d₃);
Calculate S(p, dᵣ²)=Sp²(p, dᵣ²)+Sp³(p, dᵣ²);
Calculate S(p, dᵣ²+1)=Sp²(p, dᵣ²+1)+Sp³(p, dᵣ²+1);
Calculate S(p, dᵣ²−1)=Sp²(p, dᵣ²−1)+Sp³(p, dᵣ²−1);
Select the minimum Lᵣ^{2 or 3}(p, d) from among the 8 paths costs of S(p, dᵣ²), d** is the disparity value corresponding to the selected path cost;
Perform subpixel interpolation on d** using S(p, dᵣ²), S(p, dᵣ²+1), and S(p, dᵣ²−1); and
Select the minimum of S(p, d*) and S(p, d**) and use the corresponding disparity value as the final disparity value

In operations A-E, above, the path cost calculator 402 may perform one or more of the steps that calculate a path cost Lᵣ, a partial sum Sp, or an aggregated path cost S. The winner decision block 406 may perform one or more steps that select a path cost or disparity value. Outputting a path cost Lᵣ, a partial sum Sp, an aggregated path cost S, or disparity value may include the path cost calculator 402 outputting such data to the winner decision block 406 and/or the path cost buffer 404. Loading a path cost Lᵣ, partial sum Sp, aggregated path cost S, or disparity value may include the path cost calculator 402 receiving such data from the path cost buffer 404. In some embodiments, one or more of the previous operations may be performed by a different component of the SGM/eSGM block 206 (e.g., the winner decisions block 406 may calculate an aggregated path cost S).

In some embodiments, as discussed above, the SGM/eSGM block 206 may implement subpixel interpolation using the post-processing block 408. The SGM/eSGM block 206 may implement equiangular subpixel interpolation. The equiangular subpixel interpolation for a pixel can be determined as follows:

$${subpixel}_{EL} = \{ \begin{matrix}\frac{{S}_{d + 1} - {S}_{d - 1}}{2 ( {S}_{d} - {S}_{d - 1} )} , & {S}_{d + 1} \leq {S}_{d - 1} \\ \frac{{S}_{d + 1} - {S}_{d - 1}}{2 ( {S}_{d} - {S}_{d + 1} )} , & {S}_{d + 1} > {S}_{d - 1}\end{matrix}$$

where S_{d} is the minimum path cost, and S_{d+1} and S_{d-1} are neighbor path costs, if any. The value of subpixel_{EL} is added to the disparity value corresponding to a pixel (in the notations above, d* or d**).

In some implementations, for each pixel in the image, the SGM/eSGM block 206 may provide an intermediate stereo image processing output to the AI block 216. The intermediate stereo image processing output may include the final disparity value for the pixel (i.e., d* or d**, as selected by the process described above), the one or more path costs indexed by the one or more candidate disparity values (i.e., S(d₀) through S(d₇)), and/or the path cost neighbors indexed by the one or more candidate disparity values (i.e., S(d₀+1) through S(d₇+1) and S(d₀−1) through S(d₇−1)). The AI block 216 may use at least a portion of the intermediate stereo image processing output as input to the AI model 218.

FIG. 6 schematically illustrates an example architecture of the AI model 218, according to some example embodiments. The AI model 218 may include a convolutional neural network (CNN). A CNN, which is a specific type of artificial neural network (ANN), can host multiple layers of convolutional filters. Pooling may be performed, and non-linearities may be addressed, at lower layers, on top of which a multi-layer perceptron is commonly appended.

For example, as seen in FIG. 6, an input 602 may be provided to a first convolutional layer 604(A). The input 602 may include the intermediate stereo image processing output. The first convolutional layer 604(A) may include a fully connected layer. The first convolutional layer 604(A) may include 32 filters used in that layer 604(A), in some embodiments. The first convolutional layer 604(A) may use the filters to perform convolutional operations and generate one or more feature maps as output. The output of the first convolutional layer 604(A) may be provided to a first rectifier linear unit (ReLU) 606(A). The first ReLU 606(A) may include an activation function that outputs the input if the input is greater than 0, or 0 if the input is 0 or negative.

A second convolutional layer 604(B) may receive the output of the first ReLU 606(A). The second convolutional layer 604(B) may be the same size as the first convolutional layer 604(A) or may be a different size. The second convolutional layer 604(B) may use its filters to perform convolutional operations and generate one or more feature maps as output. The output of the second convolutional layer 604(B) may be provided to a second ReLU 606(B). The output of the second ReLU 606(B) may be provided to a third convolutional layer 604(C) and the process may repeat for the third convolutional layer 604(C) and a third ReLU 606(C). The third convolutional layer 604(C) may be the same size as the first and second convolutional layers 604(A), 604(B) or may be different.

The output of the third ReLU 606(C) may be received by a pooling layer 608. The pooling layer 608 may reduce the dimensions of the input data. For example, the pooling layer 608 may reduce the dimensions of the input data from 32 to 8. The pooling layer 608 may provide its output to a fourth ReLU 606(D). The fourth ReLU 606(D) may provide its output to a softmax function 610. The softmax function 610 may convert the output of fourth ReLU 606(D) into a probability distribution to normalize the output. The output 612 of the softmax function 610 may include one or more weights, w₀ through wₙ where n is the number of weights. The one or more weights may include 8 weights (e.g., one weight per candidate disparity value generated by the SGM/eSGM process (i.e., d₀-d₇)). The AI model 218 may provide the output 612 to the disparity value calculator 220.

In one embodiment, the disparity value calculator 220 may be configured to multiply a weight of the output 612 by a respective candidate disparity value contained in the intermediate stereo image processing output. The disparity value calculator 220 may add these products together to calculate the final disparity value for the pixel. For example, where the one or more weights include 8 weights, the disparity value calculator 220 may calculate the final disparity value as w₀*d₀+w₁*d₁+ . . . +w₇*d₇.

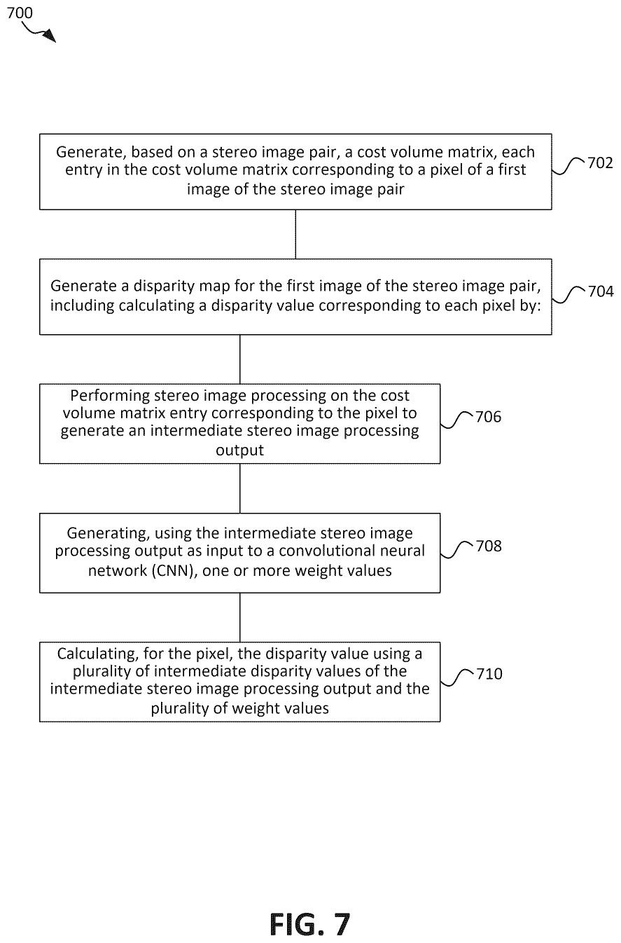

FIG. 7 is a flowchart illustrating an example method 700 for AI stereo disparity estimation. At block 702, processing logic generates, based on a stereo image pair, a cost volume matrix. Each entry in the cost volume matrix may correspond to a pixel of a first image of the stereo image pair. The cost volume matrix may include the cost volume matrix 318, as discussed above in relation to FIG. 3.

At block 704, processing logic generates a disparity map for the first image of the stereo image pair. The disparity map may include, for each pixel of the first image, a disparity value corresponding to the pixel. Calculating the disparity value corresponding to the pixel may include one or more sub-blocks 706-710.

At block 706, processing logic performs stereo image processing on the cost volume matrix entry that corresponds to the pixel to generate an intermediate stereo image processing output. Performing the stereo image processing may include performing SGM/eSGM, as discussed above in relation to FIGS. 4 and 5A-B, to generate the intermediate stereo image processing output. The intermediate stereo image processing output may include one or more path costs indexed by the one or more intermediate disparity values. The one or more path costs may include S(d₀) through S(d₇), S(d₀+1) through S(d₇+1), and/or S(d₀−1) through S(d₇−1)). The intermediate stereo image processing output may include the one or more candidate disparity values (e.g., the 8 candidate disparity values d₀ through d₇). The intermediate stereo image processing output may include the minimum disparity value of the one or more intermediate disparity values. The minimum disparity value may include the lesser of d* or d**, as discussed above. In one implementation, performing stereo image processing may include performing subpixel refinement using the minimum disparity value and one or more neighbor disparity values, as discussed above.

At block 708, processing logic generates, using the intermediate stereo image processing output as input 602 to a CNN (e.g., the AI model 218), one or more weight values, as discussed above in relation to FIG. 6. As an example, the CNN may use, as input 602, the one or more path costs (e.g., S(d₀) through S(d₇), S(d₀+1) through S(d₇+1), and/or S(d₀−1) through S(d₇−1), the intermediate disparity values (e.g., d₀ through d₇), and the minimum disparity value (e.g., d* or d**) as input 602.

At block 710, processing logic calculates, for the pixel, the disparity value using one or more intermediate disparity values of the intermediate stereo image processing output and the one or more weight values, as discussed above in relation to the disparity value calculator 220. The disparity value may be included in a disparity map at an entry corresponding to the pixel. In one embodiment, calculating the disparity value for the pixel may include multiplying each intermediate disparity value of the one or more intermediate disparity values by a respective corresponding weight value to generate one or more products and summing the plurality of products as the disparity value for the pixel. For example, as discussed above, the intermediate disparity values may include d₀ through d₇, the one or more weights may include w₀ through w₇, and calculating the disparity value may include the calculation w₀*d₀+w₁*d₁+ . . . +w₇*d₇.

Blocks 706-710 may repeat for each pixel in the first image of the stereo image pair to generate the complete disparity map with the calculated disparity values for each pixel. The system 100 of FIG. 1 or a computing device in data communication with the system 100 may use the disparity map for one or more applications, including object/pedestrian detection/tracking, SFM determination, SLAM, virtual reality applications, gaming applications, deep learning applications, or other applications.

In some embodiments, the method 700 further includes training the CNN on items of training data. Each item of training data may include a training intermediate stereo image processing output and, as a target output, a training disparity value. The intermediate stereo image processing output may include path costs, candidate disparity values, and/or a final disparity value generated from a pair of stereo images configured to provide a predetermined intermediate stereo image processing output. Training the CNN on the one or more items of training data may include calculating a loss between the calculated disparity value (a disparity value calculated based on the weights output by the CNN in response to the CNN receiving the training intermediate stereo image processing output) and the training disparity value and then adjusting one or more weights of the CNN using backpropagation and the loss.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main CPU executes some of instructions while a GPU executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
generating, based on a stereo image pair, a cost volume matrix, wherein each entry in the cost volume matrix corresponds to a pixel of a first image of the stereo image pair; and
generating a disparity map for the first image of the stereo image pair, wherein the disparity map comprises, for each pixel of the first image, a disparity value corresponding to the pixel, and wherein calculating the disparity value corresponding to the pixel comprises:
performing stereo image processing on the entry corresponding to the pixel to generate an intermediate stereo image processing output,
generating, using the intermediate stereo image processing output as input to a convolutional neural network (CNN), a plurality of weight values, and
calculating, for the pixel, the disparity value using a plurality of intermediate disparity values of the intermediate stereo image processing output and the plurality of weight values.

2. The method of claim 1, wherein calculating the disparity value for the pixel comprises:
multiplying each intermediate disparity value of the plurality of intermediate disparity values by a respective corresponding weight value to generate a plurality of products; and
summing the plurality of products as the disparity value for the pixel.

3. The method of claim 1, wherein the intermediate stereo image processing output further comprises:
a plurality of path costs indexed by the plurality of intermediate disparity values; and
a minimum disparity value of the plurality of intermediate disparity values.

4. The method of claim 3, wherein generating the plurality of weight values further comprises using the plurality of path costs and the minimum disparity value as further input to the CNN.

5. The method of claim 3, wherein performing stereo image processing further comprises performing subpixel refinement using the minimum disparity value and one or more neighbor disparity values.

6. The method of claim 1, wherein the stereo image processing comprises efficient semi-global matching (eSGM).

7. The method of claim 1, wherein the CNN comprises:
three convolutional layers; and
a pooling layer.

8. The method of claim 1, further comprising training the CNN on a plurality of items of training data, wherein each item of training data a training intermediate stereo image processing output and, as a target output, a training disparity value, and wherein training the CNN on the plurality of items of training data comprises:
calculating a loss between the calculated disparity value and the training disparity value; and
adjusting one or more weights of the CNN using backpropagation and the loss.

9. A system comprising:
one or more processing devices to perform operations comprising:
generating, based on a stereo image pair, a cost volume matrix, wherein each entry in the cost volume matrix corresponds to a pixel of a first image of the stereo image pair; and
generating a disparity map for the first image of the stereo image pair, wherein the disparity map comprises, for each pixel of the first image, a disparity value corresponding to the pixel, and wherein calculating the disparity value corresponding to the pixel comprises:
performing stereo image processing on the entry corresponding to the pixel to generate an intermediate stereo image processing output,
generating, using the intermediate stereo image processing output as input to a convolutional neural network (CNN), a plurality of weight values, and
calculating, for the pixel, the disparity value using a plurality of intermediate disparity values of the intermediate stereo image processing output and the plurality of weight values.

10. The system of claim 9, wherein calculating the disparity value for the pixel comprises:
multiplying each intermediate disparity value of the plurality of intermediate disparity values by a respective corresponding weight value to generate a plurality of products; and
summing the plurality of products as the disparity value for the pixel.

11. The system of claim 9, wherein the intermediate stereo image processing output further comprises:
a plurality of path costs indexed by the plurality of intermediate disparity values; and
a minimum disparity value of the plurality of intermediate disparity values.

12. The system of claim 11, wherein generating the plurality of weight values further comprises using the plurality of path costs and the minimum disparity value as further input to the CNN.

13. The system of claim 11, wherein performing stereo image processing further comprises performing subpixel refinement using the minimum disparity value and one or more neighbor disparity values.

14. The system of claim 9, wherein the stereo image processing comprises efficient semi-global matching (eSGM).

15. The system of claim 9, wherein the CNN comprises:
three convolutional layers; and
a pooling layer.

16. The system of claim 9, further comprising training the CNN on a plurality of items of training data, wherein each item of training data a training intermediate stereo image processing output and, as a target output, a training disparity value, and wherein training the CNN on the plurality of items of training data comprises:
calculating a loss between the calculated disparity value and the training disparity value; and
adjusting one or more weights of the CNN using backpropagation and the loss.

17. A processor comprising one or more processing units to:
generate, based on a stereo image pair, a cost volume matrix, wherein each entry in the cost volume matrix corresponds to a pixel of a first image of the stereo image pair; and
generate a disparity map for the first image of the stereo image pair, wherein the disparity map comprises, for each pixel of the first image, a disparity value corresponding to the pixel, and wherein calculating the disparity value corresponding to the pixel comprises:
performing stereo image processing on the entry corresponding to the pixel to generate an intermediate stereo image processing output,
generating, using the intermediate stereo image processing output as input to a convolutional neural network (CNN), a plurality of weight values, and
calculating, for the pixel, the disparity value using a plurality of intermediate disparity values of the intermediate stereo image processing output and the plurality of weight values.

18. The processor of claim 17, wherein calculating the disparity value for the pixel comprises:
multiplying each intermediate disparity value of the plurality of intermediate disparity values by a respective corresponding weight value to generate a plurality of products; and
summing the plurality of products as the disparity value for the pixel.

19. The processor of claim 17, wherein the intermediate stereo image processing output further comprises:
a plurality of path costs indexed by the plurality of intermediate disparity values; and
a minimum disparity value of the plurality of intermediate disparity values.

20. The processor of claim 19, wherein generating the plurality of weight values further comprises using the plurality of path costs and the minimum disparity value as further input to the CNN.
